(19) United States
(12) Patent Application Publication
(10) Pub. No.: US 2009/0169881 A1
(43) Pub. Date: Jul. 2, 2009

(54) METHOD OF PRODUCING A ROUGH COMPOSITE ELONGATED ELEMENT AND ROUGH COMPOSITE ELONGATED ELEMENT THUS PRODUCED

(76) Inventors: Christophe Ducret, Le Passage (FR); Gerard Tardy, Sonnaz (FR); Gilbert Dufayard, Le Bourget Du Lac (FR)

Correspondence Address: OWENS CORNING, 2790 COLUMBUS ROAD, GRANVILLE, OH, 43023, US

(21) Appl. No.: 11/720,672

(22) PCT Filed: Nov. 30, 2005
(86) PCT No.: PCT/FR05/51015

§ 371 Date: Jan. 25, 2008

(51) Int. Cl. B32B 19/06; B32B 37/14

(52) U.S. Cl. 428/365; 156/279

(57) ABSTRACT

A method for producing a rough elongate composite element, and a rough elongate composite element formed by the method. In the method, introduced simultaneously into a sheathing device are an essentially solid cord based on an organic material and reinforcing yarns as well as a mixture including a molten thermoplastic and at least one of the following constituents: a reinforcement and a filler, the cord being pulled by a haul-off mechanism downstream from the sheathing device. The cord is sheathed by forming a layer of the adherent mixture onto the cord, the roughness of the sheath formed in this way being created by the sheathed cord leaving the sheathing device.

The present invention relates to the field of reinforcement and more particularly relates to a method for producing a rough elongate composite element as well as the rough elongate composite element capable of being obtained by one such method.

A known reinforcing element or rebar for concrete is made of steel and in the form of a bar used as reinforcement or again in the form of rods making it possible to limit the propagation of microcracks that are likely to form in the case of stresses and to provide supplementary ductility.

While at very basic pH, oxidation of iron is nil, it becomes considerable when the pH falls and tends towards neutrality. This occurs when the alkalinity of the concrete is neutralized by chlorides resulting either from the salting of roads in winter or coming from seawater in marine applications.

In order to respond to this problem, several solutions exist, such as the addition of admixtures to concrete which consume chlorides, the protection of iron from corrosion by epoxy coatings, the use of special steels (hot-dip galvanized) or the application of a cathodic protection.

Since all these solutions are costly, new technological methods have been developed and in particular composite reinforcing elements based on a thermosetting or thermoplastic resin reinforced by yarns, generally of glass yarns.

A composite rebar is an economical asset by virtue of the absence of deterioration of mixing and metering installations, metal rebars that are conventionally used being increasingly costly. A composite rebar has moreover a lower density, close to that of concrete.

Document JP2003335559 discloses a composite cord associating a thermoplastic polymeric matrix and glass fibres. This cord moreover has an irregular surface in order to encourage keying in the concrete.

This irregular surface is obtained by passing a composite cord into a die having a pattern adapted to this end.

This production method lacks flexibility in that it requires the use of as many dies with complex forms as there are types of required roughness.

The object of the invention is to provide composite reinforcing elements of any size, or any profile, and in particular with a surface roughness that can be modified, the production of which is easy and/or rapid as well as economical on an industrial scale.

The invention will be described more particularly for the reinforcement of hydraulic setting matrices or cementitious materials (cement, concrete, mortar, gypsum, composites formed by reaction of lime, silica and water etc.) and particularly concretes, but the invention is not limited to this type of material—for example it is possible to consider a reinforcement made of organic material.

To this end, the invention provides a method for producing a rough elongate composite element in which:
there are introduced simultaneously, into a sheathing device, an essentially solid cord based on an organic material and reinforcing yarns as well as a mixture comprising a molten thermoplastic and at least one of the following constituents: a reinforcement and a filler, the cord being pulled by a haul-off means downstream from the sheathing device,
the cord is sheathed by forming a layer of the adherent mixture onto the cord, the roughness of the sheath formed in this way being created by the sheathed cord leaving the sheathing device.

The method according to the invention thus provides a simple method for obtaining roughness by appropriate sheathing of a cord. The extent and regularity of the roughness are influenced by the choice of mixture and in particular by the following parameters:
the viscosity of the mixture,
the intrinsic viscosity of the thermoplastic,
the amount and aspect ratio of the reinforcements and fillers (ratio of the largest dimension to the smallest dimension),
the capacity of reinforcements or fillers to expand in the thermoplastic.

Some reinforcements and fillers, for example individual fibres and/or filaments, can contribute alone (that is to say whatever are the conditions for the formation of the layer according to the invention) to obtaining roughness.

In the present invention, a reinforcement denotes any product that is neither soluble nor miscible which, mixed with the thermoplastic, can improve one or more properties or characteristics (electrical, mechanical, chemical properties, etc.).

The reinforcements can be of a variable chemical nature (organic or inorganic).

Their geometry can also be variable:
granular or spherical (for example beads of glass, CaCO₃ with an aspect ratio equal to 1),
lamellar, for example talc with an aspect ratio equal to 10,
acicular, for example a wollastonite with an aspect ratio equal to 10-20,
fibrillar or filamentary.

A filler denotes a relatively inert solid material intended to modify its stability or to reduce costs.

The reinforcing yarn denotes any yarn or any fibre capable of improving the mechanical properties of the element.

The sheath can have smooth zones or zones that are slightly rough alternating with very rough zones.

The method according to the invention is suitable for cords of any shape, for example circular, elliptical, triangular, square, star-shaped, multi-lobed, or in the shape of a regular or irregular polygon. The cord can also be of a rectangular shape and more generally form a profile (T-shaped, U-shaped etc.). The cord can also be twisted which makes it possible if needs be for the cord to conform more easily (for example formation of a composite reinforcement for example). The cord is for example pultruded.

Roughness can be produced by the method according to the invention for any shape and any size of composite element.

In addition, production of the sheath and formation of the cord are carried out for example continuously.

Preferably, the layer covers all the cord but partial sheathing can also be considered, the cord being bare over one or more given lengths, or can even be asymmetric, the cord being bare over part of the circumference.

In an advantageous embodiment, when said mixture is pressed during the formation of said layer, the pressure is adjusted according to said constituents and at least one of the following parameters: the feed rate of said mixture, the pull speed of said cord, the dimensions of the zone of the sheathing device, and the size of the outlet opening of the sheathing device.

Expansion of the layer causes it to burst, contributing to, or being sufficient to give a rough appearance to the layer.

A sufficient pressure level is particularly important in order to obtain optimum roughness when the aspect ratio of the constituents (reinforcement and/or fillers) is low. As an example, when the constituents are of the filamentary type, such as glass filaments, the surface roughness is obtained for any pressure value, even a low one.

Expansion can be obtained by choosing the operating condition. The degree of entrainment of the mixture by the cord is chosen by varying the pull speed.

The quantity of mixture deposited on the cord is mainly influenced by the given flow rate at the feed means, typically an extruder, for a given sheathing device. For example, the rotation of the screw may be varied. The characteristics of the sheathing device can also be chosen, in particular the geometry and dimensions of the feed channel or channels.

It is also possible to adjust the relative flow rate of the mixture in relation to the cord or vice versa and/or to adjust the pressure and temperature in the zone for the formation of the layer.

The size of the outlet opening of the device (for example easily interchangeable) is preferably chosen to be slightly greater than the transverse dimension of the cord. The difference is to be adjusted according to the desired roughness level and/or the desired thickness. For example, an opening is chosen having between a tenth to five tenths of a millimetre more.

The sheath can have smooth zones or slightly rough zones alternating with very rough zones. The roughness can be varied by modifying the operating conditions, for example by simple manual adjustment or by automatic control of flow rates and the pull speed of the cord.

The inlet opening of the sheathing device, which is for example a die, has a shape adapted to the shape of the cord.

In the method according to the invention, care is taken that the layer adheres to the cord. Naturally, identical or similar organic materials are chosen for the cord and layer, or at least are made chemically compatible, so as to be intimately bonded in order to form a continuous interface guaranteeing lasting mechanical properties.

The cord can be a rigid cord or made of thermosetting organic material having undergone surface treatment in order to promote adhesion (flaming, microabrasion etc.) on the cord or furthermore a cord in process of curing. Vinyl esters that are particularly corrosion resistant, or polyesters, phenolics, epoxides or acrylics may for example be chosen.

In a preferred embodiment, a thermoplastic organic material is chosen for the cord on account of its ease of application, the absence of the emission of solvent or of a chemical reaction, and of the competitive production rate.

In the sheathing device, the viscosity is “fixed” (by choice of the sheathing material) and can be modified to some extent according to the adjustment to the temperature profile. If this viscosity is too high, the cord will have difficulty in entraining the sheath and conversely, if the material is too fluid, it will have difficulty in remaining on the cord, and therefore in keeping a sheath with a “constant geometry” (the product flowing by gravity).

In the sheathing device, the temperatures of the cord and of the sheathing material are adjusted so that chemical keying is achieved (polyfusion of two components bringing about a continuity of the interface) in addition to mechanical keying.

The rough sheath can be set in the open air. The rough sheathed cord can preferably be cooled in order to accelerate production.

A polyolefin can be chosen, in particular polyethylene or polypropylene, or a polyamide, polystyrene, polyvinyl chloride, ABS, polybutylene terephthalate or polyethylene terephthalate (PET), polycarbonate, polyurethane or polyurea (TPU).

Preferably, the organic materials (cord and sheath) are based on a polyolefin such as polypropylene which has many advantages including resistance to an alkaline medium (on account of its chemical inertness), ease of application and low cost.

Preferably, the reinforcement can comprise filaments dispersed in the molten material.

The reinforcement can be inorganic and/or organic, for example made of glass, aramid, graphite, carbon or combinations of these types of reinforcement.

Even more preferably, the filaments comprise filaments of alkali-resistant glass.

Alkali-resistant glass (commonly called AR-glass) is particularly advantageous for giving a guarantee of durability of performance in very alkaline media to be reinforced, such as concrete. Indeed, the characteristics of glasses conventionally used (E-glass for example) or S-glass, for the reinforcement of organic resin degrade quite rapidly by diffusion of the corrosive solution in the medium to be reinforced.

AR-glass generally contains zirconium oxide ZrO₂. These yarns can be chosen from any existing “alkali-resistant” glass yarns (such as those described in patents GB 1 290 528, U.S. Pat. Nos. 4,345,037, 4,036,654, 4,014,705, 3,859,106 etc.) and preferably include at least 5% in moles of ZrO₂. According to one embodiment of the invention, the glass constituting the yarns comprises SiO₂, ZrO₂ and at least one alkali metal oxide, preferably Na₂O, as the main constituents.

An alkali-resistant glass composition that is particularly used to produce glass yarns according to the invention is the composition described in patent GB 1 290 528, composed mainly of the following constituents in proportions expressed in molar percentages: 62-75% SiO₂; 7-11% ZrO₂; 13-23% R₂O; 1-10 % R′O; 0-4% Al₂O₃; 0-6% B₂O₃; 0-5% Fe₂O₃; 0-2% CaF₂; 0-4% TiO₂; R₂O representing one or more alkali metal oxides, preferable Na₂O and possibly Li₂O and/or K₂O, and R′O being one of the constituents chosen from alkaline earth oxide ZnO and MnO.

Moreover, with AR-glass, the elongate composite element can be used in another corrosive environment, a wet environment, an acid environment, a saline environment etc.

In addition, the reinforcing yarns used can be made of an inorganic and/or organic material, for example glass, aramid, graphite, carbon or combinations of these fibres.

The reinforcing fibres are for example multifilament glass fibres. Generally, the production of glass fibres is carried out in the following manner: streams of molten glass are mechanically attenuated (at speeds of several metres to tens of metres a second) in the form of one or more bundles of continuous filaments, for example 800 to 4000 filaments, from the orifices of one or more bushings, and the filaments (having a diameter between 10 and 30 μm) are coated with a sizing composition before being brought together into one or more yarns.

This size permits optimum coupling between the thermoplastic or thermosetting organic matrix and the AR-glass yarn and provides lasting mechanical performance. A size associating silanes and polymers compatible with the matrix to be reinforced may be used, for example one of the sizes described in patent FR 2837818.

The cord may be made of E-glass and the rough sheath of AR-glass.

Preferably, the reinforcing yarns comprise alkali-resistant glass filaments and/or alkali-resistant glass yarns.

In addition, the reinforcements, for example individual filaments and/or fibres, and/or fillers as well as the solid organic material, can be introduced simultaneously into an extruder.

Before the mixture is introduced, at least part of said mixture can be prepared by unreeling wound multifilament yarns, chopping said yarns to form fibres and dispersing them in an extruder feeding the device for sheathing said fibres in said thermoplastic.

This method can be carried out continuously, and by using one or more reels or cakes carrying yarns that are separate, unassembled or not, and that are preferably made of glass. The filaments of each fibre split apart during dispersion.

A twin-screw (rotating, co-rotating) extruder can be chosen.

Before said introduction of the mixture, at least part of said mixture can be prepared by incorporating, in an extruder feeding the sheathing device, at least one compound comprising filaments of said thermoplastic (granulated, ready-to-use compound, multicomponent metering etc.).

A single-screw extruder can be chosen.

The aforementioned methods for forming a mixture can also be combined.

Short filaments can be used, preferably between 5 and 50% by weight of the mixture of filaments, even more preferably between 20 and 30%.

In the present invention, short filaments are understood to mean filaments with a mean length less than or equal to 0.5 mm. These can be found for example in commercial composite pellets, their length being generally between 0.2 and 0.3 mm in these pellets. The distribution of these filaments in the organic material is generally isotropic.

After the mixture has been prepared, these short filaments dispersed in the molten material can have a mean length similar to the starting filaments even if the mixture is produced by an extruder. Long filaments can also be used, preferably between 5 and 40% filaments by weight of the mixture, even more preferably between 10 and 30%.

In the present invention, long filaments are understood to mean filaments with a mean length greater than 0.5 mm. They are found for example in commercial long fibre composite pellets (GFL type), and their length is for example equal to 12 mm in these pellets. Distribution of these filaments in the organic material is unidirectional.

Under the effect of mixing (temperature, shear), these long filaments are cut and then have a shorter residual mean length that varies according to the tools and the plasticizing unit of the extruder (screw profile, dimensions etc.) and the distribution of lengths lies for example between approximately 0.5 and 5 mm (measurable after the product has been calcined).

Long and short filaments can be used at the same time, and/or starting with multifilament fibres that have or have not been blended together, for example a yarn marketed by Vetrotex under the tradename Twintex®.

Moreover, in order to promote chemical compatibility between the layer and cord, for example between two polypropylenes, a coupling agent can be provided in the mixture, for example a polypropylene grafted with polar groups, for example maleic anhydride.

All things being moreover equal, roughness is more accentuated with long cut filaments than with short filaments. Long cut filaments give a fluffy or expanded appearance.

The filaments of the sheath are not necessarily directed substantially perpendicularly with respect to the axis of the cord.

Talc can also be used (alternately or in combination with filaments). This type of element gives a “bulgy” or swollen appearance.

Fillers can be chosen, preferably mineral fillers and between 5 and 50% by weight of the mixture, in particular ground glass or glass flakes.

The method can include a step for forming the cord including the introduction of a bundle of reinforcing yarns associated with the organic material in a device for forming the material, in order to obtain said cord made by bringing yarns together contiguously, forming transverse continuity.

In order to form the cord, the reinforcing yarns (for example those made of glass) can be entrained and assembled together and these yarns can be immersed in a bath of organic resin or furthermore can be impregnated in a sheathing die fed by a fluid thermoplastic matrix.

The step of forming the cord can contain the following operations:
composite yarns formed from continuous glass filaments and the chosen thermoplastic organic material co-blended together in the form of at least one bundle are entrained and assembled in a parallel manner,
the bundle is passed into a zone where it is heated to a temperature reaching at least that of the melting point of the thermoplastic organic material,
the bundle is passed into an impregnating device, while its temperature is maintained at a temperature at which the thermoplastic is maleable, in order to distribute molten thermoplastic organic material uniformly and to impregnate the filaments with this.

By virtue of the use of a composite yarn, the method according to the invention has many advantages:
no addition of material,
ease of producing a pultruded cord,
better impregnation and distribution of yarns in the thermoplastic, giving high cohesion and increased durability in concrete,
possible adjustment of the content of thermoplastic.

It is possible to chose for example a yarn marketed by Vetrotex under the trade name Twintex® and preferably produced by the method described in patent EP 0 599 695, which consists of glass filaments and filaments of thermoplastic organic material, of the polyolefin or polyester type, intimately blended together.

Finally, the production device can include, at the end of the line, a cutting tool, for example shears, in order to cut the rigidified rough sheathed cord.

The invention also provides a rough elongate composite element comprising a core based on an organic material and reinforcing yarns and which is covered with a rough sheath based on a thermoplastic and at least one of the following constituents: a reinforcement and a filler, said element being capable of being obtained by the method as previously described.

The products according to the invention have in point of fact sheaths with novel raised portions especially efficient as a reinforcement.

These raised portions increase the contact area between rebar and concrete, increase anchorage of elements in the concrete as well as the tenacity of the rebar/concrete bond and promote transfer of load between the concrete and the rough element.

Preferably, the rough sheath according to the invention can be substantially uniform in its thickness and in particular be obtained from a substantially uniform mixture of thermoplastic and of other reinforcing constituent or constituents and/or filler or fillers.

The element according to the invention can be a rod, typically with a length between 10 and 80 mm, having a total diameter less than or equal to 3 mm.

Such a rod makes it possible to prevent sudden collapse of cracked reinforced concrete by promoting local and progressive ruptures.

The element according to the invention can also be a reinforcement, typically with a total diameter between 6 and 20 mm. Its cross section can be substantially in the form of a bone, that is to say a flat central part and two rounded lateral ends, in order to reinforce rigidity in the desired directions. This reinforcement can in addition be curved with a variable cross section along its axis, with deformed longitudinal ends (in hooks, etc.).

The element can also serve to repair existing structures. The roughness of the sheath can represent up to 25% of the thickness of the cord (diameter in the case of cylindrical symmetry). It is preferably less than 3 mm, and even more preferably between 0.2 mm and 1 mm, in order to keep a sufficient key between the cord and the concrete.

The amount of glass by weight in the core can be greater than or equal to 30% preferably greater than or equal to 60%. The amount of glass by weight in the sheath can be between 5 and 50%, for example between 15 and 35%.

The rough sheath can have a fluffy appearance while remaining rough to the touch. In this configuration, the maximum amplitude of the roughness can preferably be between 0.2 mm to 1 mm.

The reinforcement can comprise filaments with a distribution of lengths of between 0.5 and 5 mm, centred for example on 2 mm.

The reinforcement can include filaments with a mean length of between 0.2 and 0.5 mm.

The appearance is therefore granular and the surface seems covered with small grains, these grains being in reality filaments. The surface is rough to the touch. The maximum amplitude of roughness is then 0.05 mm to 1 mm, preferably between 0.1 and 0.5 mm.

The reinforcement can also include talc.

The rough sheath can be provided with beads, in this way having a swollen appearance.

Each bead can be an elongate bulge with a smooth appearance having a width of the order of a millimetre and a height extending to a few millimetres.

The invention also provides a matrix with a hydraulic binder incorporating the element capable of being obtained by the method as previously described.

Suitable hydraulic setting binders are understood to be materials that contain an inorganic cement and/or an inorganic binder or adhesive that hardens by hydration. Particularly suitable binders that harden by hydration are in particular, for example, Portland cement, cement with a high alumina content, Portland blast furnace slag cement, trass cement, slag cement, plaster, calcium silicates formed by treatment in an autoclave and combinations of special binders.

The quantity of elements according to the invention can for example be between 5 and 50 kg/m³ of concrete.

They can be incorporated in sprayed concrete installations (slabs, partitions etc.) containing for example a mixture of elements according to the invention with fibres and/or filaments of alkali-resistant glass and/or anti-crack fibres (AntiCrak®) in particular of the high performance (HP) type or of the high dispersion type (HD) which are sold by Vetrotex or furthermore of polypropylene fibres or phenolic fibres.

Naturally, the invention also relates to any element based on a matrix with a hydraulic binder reinforced with the rough composite element as previously defined.

It can consist of an element used in the structural decoration of a building or for slabs, partitions, overhanging structures, cornices.

Other details and advantageous features of the invention will become apparent on reading the examples illustrated by the following figures:

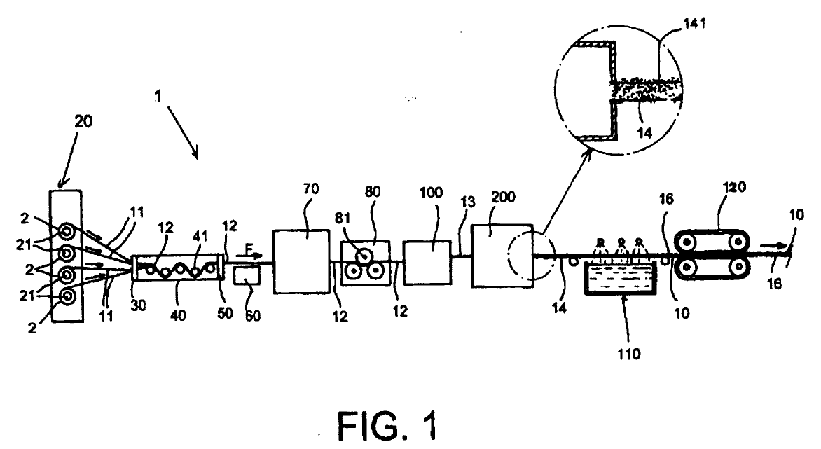

FIG. 1 represents a diagrammatic profile view of a device for producing a rough elongate composite element in the first embodiment of the invention,

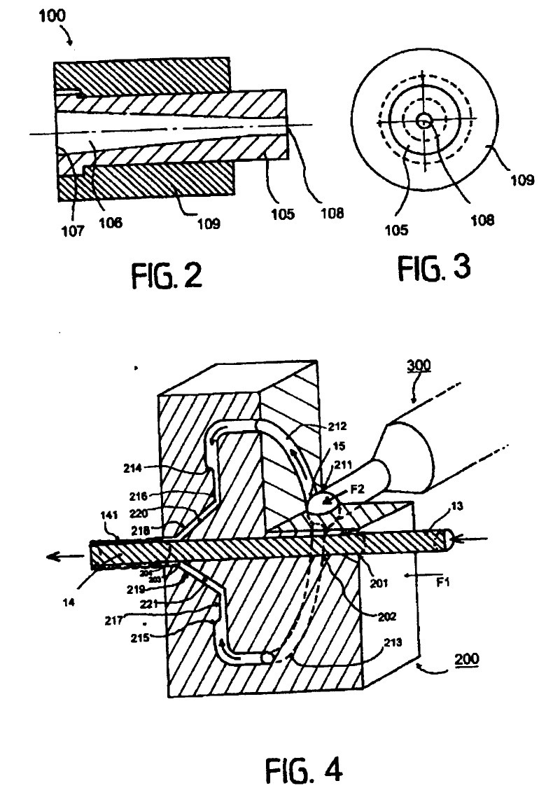

FIGS. 2 to 4 are views of forming and sheathing devices of the device of FIG. 1,

FIGS. 5 to 8b show three rough elongate composite elements according to the invention obtained by applying the method according to the invention, with the aid of the device of FIG. 1.

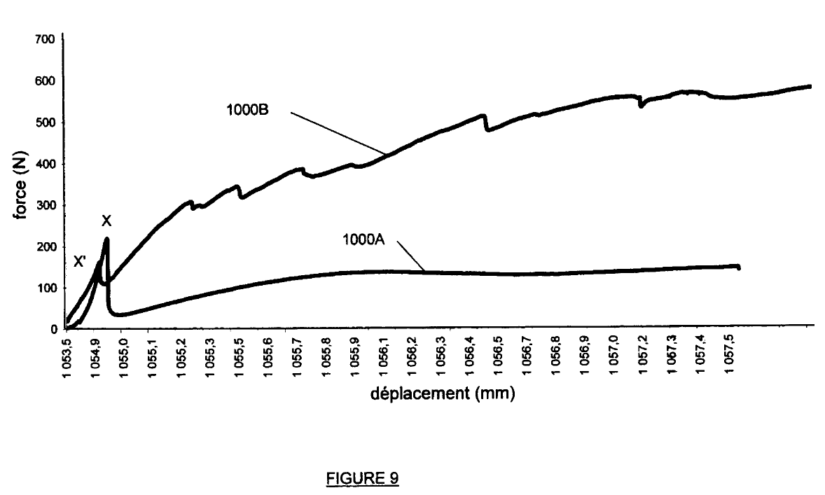

FIG. 9 shows changes in force (in N) as a function of the movement of the traverse for beams with a smooth composite elongate element or a rough composite elongate element according to the invention.

FIG. 1 represents a diagrammatic profile view of a device for producing a rough elongate composite element in a first embodiment of the invention.

The device 1 that can be seen in FIG. 1 enables a rough elongate composite element 10 according to the invention to be produced which comprises:
a core, for example of a circular shape, based on reinforcing yarns arranged in a parallel and contiguous manner against each other and secured together by an organic material, preferably thermoplastic, organic material,
a rough sheath in intimate contact with the core and based on a thermoplastic (preferably polypropylene) mixed with reinforcements (preferably AR-glass filaments and/or talc and/or fillers).

The core can be obtained from composite yarns consisting of continuous glass (preferably AR-glass) filaments and continuous filaments of a thermoplastic organic material, preferably polypropylene, intimately blended together. Each composite yarn is for example produced by the method described in patent EP 0 559 695. The composite yarns preferably comprise at least 60% glass by weight, for example 75%.

The production device 1 comprises, in the form of a line and from upstream to downstream, a creel 20 provided with several reels 2 constituting the wound yarn 11, an eyelet plate 30, a device for regulating the tension of the yarns 40, a comb 50, possibly an anti static electricity device 60, an oven 70, an impregnating device 80, a forming device 100, in particular a die, a sheathing device, in particular a die 200, an extruder, a cooling tank 110 and a caterpillar haul-off 120.

The object of the creel 20 is to unwind or unreel the yarn 11 from each reel 2. It can for example be of the unwind type and be composed of a frame provided with horizontal rotating spindles 21 each supporting a reel 2.

The eyelet plate 30 is situated in a vertical plane and parallel to the rotating spindles 21 of the creel. It makes it possible to group the yarns 11 together, each of which passes through an eyelet in order to be guided towards the tension-regulating device 40 at a suitable angle for the desired tension. The eyelets are in a known manner made of a ceramic in order to prevent damage to the yarns as they pass through them.

The tension-regulating device 40 is associated with the eyelet plate 30. It comprises a series of cylindrical bars 41 positioned in a staggered manner one above the other and, on and under which the yarns 11 travel coming from the eyelet plate 30 so as to describe identical sine waves of which the amplitude influences the tension of the yarns. The bars are adjustable in height so as to be able to modify the amplitude of the sine waves which, by being increased, give additional tension to the yarns.

The bars are advantageously made of brass or of a ceramic material in order to limit static electricity phenomena induced by friction of the yarns.

A comb 50 is positioned at the exit from the device 40 of which the teeth group together and align the yarns 11 in a parallel manner with regular spacing so as to obtain a bundle 12 in the manner of a cord of yarns.

Between the comb 50 and the entry to the first oven 70, an electrical device 60 is implanted serving to destroy any static electricity with which the yarns 11 could be charged so as to prevent said yarns expanding, which could otherwise bring about their deterioration in the oven 70.

The oven 70 is an infrared oven. It could also consist of an oven operating with hot air convection.

Heating the bundle 12 by passing it into the oven 70 is carried out at a temperature so that, as it leaves the oven, the bundle has sufficient temperature to reach the melting point of the thermoplastic of the yarns 11. The molten thermoplastic bonds and is embedded in the continuous glass filaments of the assembly of the bundle 12.

The oven 70 can consist of two (or even more) successive ovens: the first oven, upstream from the second with respect to the direction of progression. The first oven has the function of heating the bundle 12 as described above, while the second oven has the function of maintaining the temperature above the melting point and of increasing the production rate.

An impregnating device 80 is situated after the oven 70 which flattens the bundle 12 so as to distribute the molten thermoplastic bundle uniformly over the width and to guarantee total impregnation of the glass filaments by the thermoplastic.

The impregnating device 80 consists of three units positioned in a triangle between which the bundle 12 passes. In a first embodiment, the units can consist of fixed bars of which the separation is adjusted so as to regulate the pressure necessary for impregnation. The bars are heating bars.

The upper cylinder is adjustable for height in order to establish sufficient pressure on the bundle 12 so as to ensure impregnation of the glass by the thermoplastic.

It should be noted that it would be possible to imagine an oven in which the impregnating device 80 would be housed and which would be able to withstand the temperature of the oven.

A forming device 100 is placed at the exit from the oven which can comprise a die with a suitable calibrated cross section in order to form the bundle to the desired form and dimensions for the core. Several dies can also be used.

According to various embodiments, the orifice of the die can be substantially circular in order to form a core in the form of a rod, or a core with a more complex form in order to form a core matching a particular profile.

The orifice of the die can be of any other form, for example rectangular in order to form a ribbon.

The orifice of the die is advantageously made in a detachable part which is fastened on a fixed support which permits easy cleaning and replacement.

The die is advantageously a heating die keeping the formed surfaces at a temperature close to the melting point or to the maleability temperature of the thermoplastic of the bundle. Heating by one or more electrical resistance heating collars closely encircling one or more zones of the die can for example be used.

FIGS. 2 and 3 represent the forming device 100 consisting of a die. The latter comprises a substantially cylindrical body 105 comprising a wide opening 107 upstream through which the bundle 12 is introduced, a conical cavity 106 of which the height decreases to a desired diameter of the cord (as a rod) to form, downstream, an emerging circular cavity 108, for example 5 to 20 mm long through which the formed cord 13 leaves.

Part of the substantially cylindrical body 105 is positioned in a heating body 109. Heating can in particular be provided by electrical resistances in the form of heating belts positioned around the heating body 109.

The object of the device 100 is to transform the bundle 12 into a cord 13 with a constant diameter (rod) made by bringing the yarns 11 together contiguously so as to produce a transverse continuity of said cord. In this way, the device 100 concentrates the bundle around the central axis of the line in order to reduce its diameter which had been increased during its passage through the impregnating device 80, and to realign it with respect to the central axis of the production lines so as to guide the cord suitably downstream.

The sheathing device 200, seen in FIG. 4, is situated after the forming device 100. This sheathing device 200 is a die fed on the one hand by the cord 13 obtained as described above and, on the other hand, by a means 300, in particular an extruder known to a person skilled in the art, which brings, under pressure, a mixture 15 based on a molten thermoplastic organic material (for example polypropylene) and fillers and/or reinforcements, for example of chopped AR-glass filaments.

FIG. 4 shows a partially exploded section of this sheathing device 200, shown in perspective. The section is made perpendicularly to the central plane of the cord 13 and in the direction of progress of the cord 13. The exploded part makes it possible to visualize the means 300 for bringing the mixture 15 and also the path of the latter 15 in the sheathing device 200.

The sheathing device 200 comprises an inlet 201 for the cord 13, introduced in the direction of the arrow F1 and an inlet 211 for the mixture 15 introduced in the direction of the arrow F2.

The cord 13 moves forward in a cavity 202 to end up in an emergent cavity 203, with a length typically between 5 and 20 mm opening onto the outlet 204.

The mixture passes through the channels 212, 213, situated away from the cavity 202. These channels are designed to feed the cavity 203 with the mixture 15 from several sides.

The channels 212, 213 have for example narrowings 214, 215 in order to emerge into the channels 216, 217 that have a cross section less than that of the channels 212, 213 and emerge into the cavity 203. In this way, excess pressure is created on the mixture 15 promoting intimate contact between the mixture 15 and the cord 13, while preventing backflow upstream of the mixture on entering the sheathing die. Excess pressure on such a mixture also contributes to the creation of the roughness of the sheath 141 as soon as it leaves the device.

The cavity 203 can be designed so that the mixture 15 converges in a uniform manner in all directions around the cord 13. In order to obtain this function, a tapered guide 220 can in particular be used having inclined walls 218, 219 situated around the cavity 202.

In a variant, the feed can be from only one side when an asymmetrical element is desired.

It should be noted that the position of the extrusion device 300 shown here as a crosshead is in no way limiting and indeed it can be situated in any position around the axis of the path of the cord 13.

Final cooling of the rough sheathed cord 14 is carried out by means of a cooling tank 110 in particular a water bath, through which the rough sheathed cord 14 passes as it progresses. The bath 110 can include means for spraying the cooling liquid onto the rough sheathed cord 14.

During all its cooling, all the mass of the thermoplastic of the sheath 141 sets giving the desired rough sheath 16, as well as the thermoplastic of the core enabling the fibres to be secured together and the fibrous reinforcements to be bonded to the sheath.

A caterpillar haul-off 120 is installed behind the cooling tank which constitutes in a known manner a means for entraining the yarns and the cord, exerting a traction force along the line. It sets the speed of reeling and traction of the bundle and then the cord 13.

Finally, the production device can include, at the end of the line, shears or a saw (not shown) intended to cut the rigidified rough cord so as to form the rough elongate composite element 10 suitable for reinforcing a cement matrix.

Implementation of the Method

The method can be implemented in the following manner.

The method is first of all started by drawing and leading each yarn 11 manually from the reel 2 to a drawing frame 120 where each yarn is then held clamped, all the yarns passing through the various devices described above.

The oven 70, as well as the heating elements of the device 1 are raised in temperature so as to reach a temperature clearly greater than the melting point and chosen according to the pull speed.

The other means operate at the following temperatures:
components of the impregnating device 80: 200 to 250° C.;
forming device 100: 200° C.

The drawing frame 120 is put into operation, and unreeling from the reels 2 commences.

The pull speed is for example 5 to 10 m/min but can reach 50 m/min without difficulty.

The yarns 11 pass through the eyelets and then across the bars in the device 40 and are brought together through the teeth of the comb 50 in order to form the bundle 12 with parallel fibres as they leave.

The bundle 12 then re-enters the oven 70 so that the thermoplastic of the composite yarn reaches its melting point. As it leaves, it passes between the heating rolls of the device 80 which enable it to be flattened and the thermoplastic covering it as well as the glass filaments to be distributed uniformly.

It should be noted that the quantity of thermoplastic is not to be metered since it is directly incorporated in the raw material of the cord by being co-blended with the glass filaments.

The temperature of the bundle reaches a temperature of 180° C. to 200° C., after passing through this device 80.

The bundle 12 then passes through the die of the forming device 100 to be converted into a cord 13 formed into a rod by pressing the yarns against each other and by arranging them in a contiguous manner. After forming, the cord 13 has a temperature below 160° C.

The diameter of the die 100 as well as the diameter at the inlet to the sheathing device 200 depend on the type and number of reels.

The cord 13 enters the sheathing device 200 after a distance where it cools a little. The device 200 is fed simultaneously with the mixture 15.

The threshold pressure is adjusted in the sheathing device 200 according to the choice of reinforcements and/or fillers in order to obtain a particularly rough sheathed cord 14 at the outlet 204 of the sheathing device 200. When the reinforcements are glass filaments, the roughness of the surface is obtained by any pressure value.

In a first example of the production of a rough cord or mini rebar (see FIG. 5) 14 reels of wound composite yarns (rovings) are chosen individually equal to 399 tex. It is also chosen to prepare a mixture that contains 70% by weight of polypropylene (PP) in the molten state and 30% chopped AR-glass filaments. This mixture is obtained by pouring pellets with short glass filaments into the extruder.

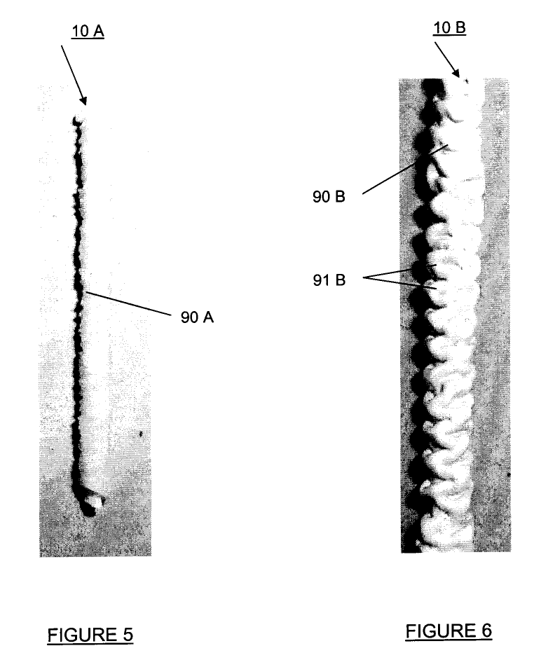

In a second example of the production of a rough rebar (see FIG. 6) 14 reels of wound composite yarns (rovings) are also chosen individually equal to 399 tex. It is also chosen to prepare a mixture that contains 70% by weight of polypropylene (PP) in the molten state and 30% talc. This mixture is obtained by pouring pellets based on talc into the extruder.

In these two examples of the production of a rough mini rebar, the diameter of the die 100 is equal to 2.2 mm and the inlet diameter of the sheathing die 200 is equal to 2.1 mm, the outlet diameter 204 is equal to 2.4 mm, and the temperature in the cavity 203 is equal to 175° C. The extruder speed is for example 5 rpm and the pull speed is 10 m/min.

In a third example of the production of a rough mini rebar, 3 reels of wound composite yarns (rovings) are chosen individually equal to 1800 tex. It is also chosen to prepare a mixture that contains 60% by weight of polypropylene (PP) in the molten state and 40% chopped AR-glass filaments that are ground to a varying extent and split up individually. This mixture is obtained by pouring PP pellets and pellets having 75% glass and comprising 12 mm long glass filaments.

Table 1 below presents the conditions for producing two mini rebars with a smooth sheath n° 3a and 3b and five mini rebars with a rough sheath n° 3c to 3g, at various temperatures and pressures.

TABLE 1

| | | | | Mean |
|---|---|---|---|---|
| | | | | temperature |
| | | Temperature of | | before the |
| Reference of | | material in the | Extruder | sheathing |
| mini rebars | Pull speed | extruder | pressure | device |
| N° 3a | 15 m/min | 230° C. | 40 bar | 150° C. |
| comparative | | | | |
| N° 3b | | | | 190° C. |
| comparative | | | | |
| N° 3c | | 230° C. | 80 bar | 145° C. |
| N° 3d | | | | 185° C. |
| N° 3e | | | 95 bar | 150° C. |
| N° 3f | | | | 200° C. |
| N° 3g | | | 80 bar | 145° C. |

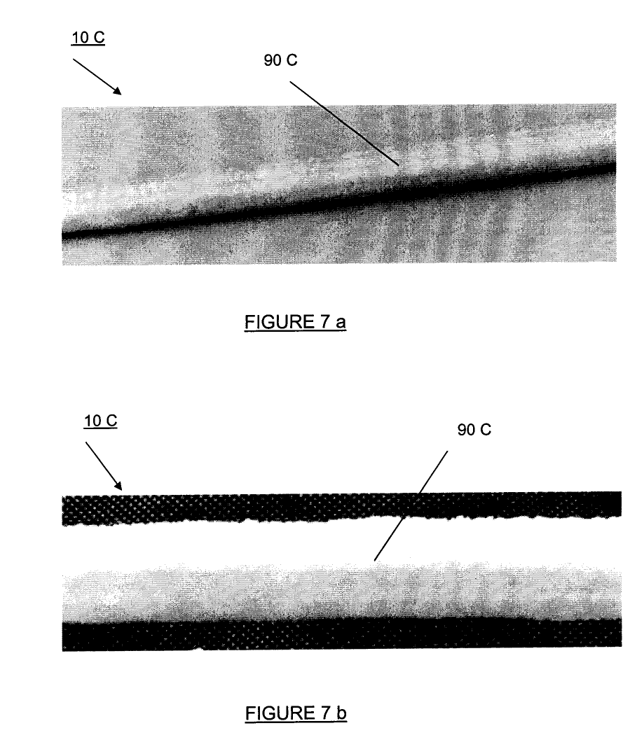

In an example of the production of a rough rebar (see FIGS. 7a and 7b) 285 reeled composite yarns (rovings) are chosen from 57×5 assembled rovings, the individual linear density being equal to 400 tex. It is also chosen to prepare a mixture that contains 70% by weight of polypropylene (PP) in the molten state and 30% chopped AR-glass filaments. This mixture is obtained by pouring pellets containing short glass filaments into the extruder.

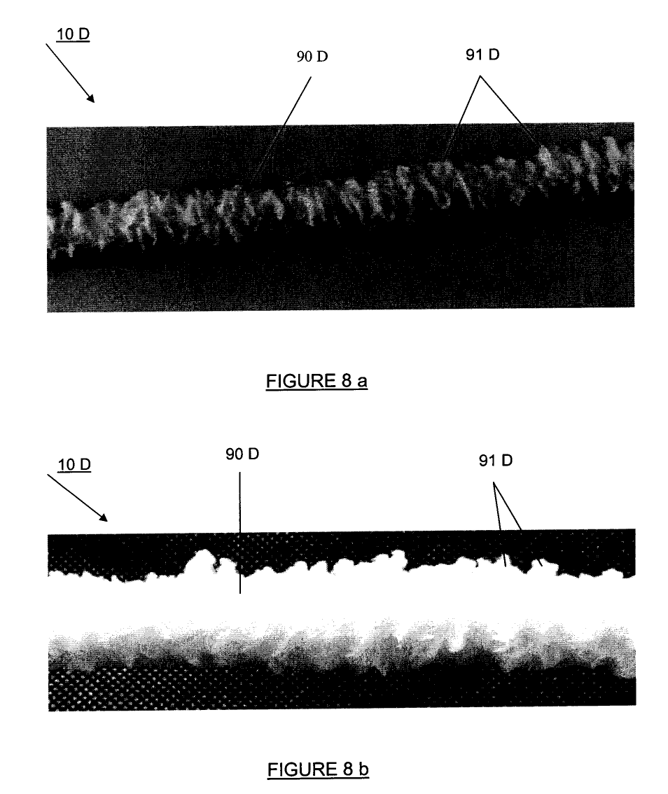

In a second example of the production of a rough rebar (see FIGS. 8a and 8b) 285 reeled composite yarns (rovings) are chosen from 57×5 assembled rovings, the individual linear density being equal to 400 tex. It is also chosen to prepare a mixture that contains 70% by weight of polypropylene (PP) in the molten state and 30% chopped AR-glass filaments that are ground to a varying extent and split up individually. This mixture is obtained by pouring pellets of PP and pellets with 75% glass and comprising 12 mm long glass filaments.

In these two examples of the production of a rough rebar, the diameter of the die 100 is equal to 10.1 mm and the inlet diameter of the sheathing die 200 is equal to 10 mm, the outlet diameter 204 is equal to 10.2 mm, and the temperature in the cavity 203 is equal to 210° C. The extruder speed is for example 5 rpm and the pull speed is 10 m/min.

FIGS. 5 and 6 show photos (that are not to scale) of cords or min rebars 10A, 10B respectively, obtained by the method described above with the aid of the device of FIG. 1.

The first mini-rebar 10A (FIG. 5) has a rough surface 90A with a granular appearance. The AR-glass filaments are dispersed in the sheath and are oriented or not along the longitudinal axis. The filaments for the most part retain their initial length of approximately 0.2 mm. The maximum amplitude of the roughness is estimated at approximately 0.2 mm.

The second mini rebar 10B (FIG. 6) has a bulgy sheath surface 90B. The rough sheath is provided with beads 91B, giving this swollen appearance. Each bead 91B is a relatively smooth elongate bulge with a width of the order of a millimetre and a height (with respect to a hollow) equal to 1.5 mm.

The length of the mini rebars 10A, 10B is equal to 50 mm.

FIG. 7a is a photograph (which is not the scale) of the rebar 10C.

This rebar 10C has a rough surface 90C with granular appearance similar to that of the mini rebar 10A.

FIGS. 8a to 8b show photographs (which are not to scale) of the rebar 10D.

The sheath 90D has a marked roughness in the form of a succession of “collars” 91D surrounding the core. The maximum amplitude of the roughness is of the order of a millimetre.

The length of the rough rebars 10C, 10D is equal to 50 mm.

In addition, it is also possible to produce composite reinforcements or even composite meshes resulting from the assembly of rough rebars according to the invention.

It is moreover possible to replace at least the thermoplastic of the core of a rough (mini) rebar according to the invention by a thermosetting resin by adapting the pultrusion and sheathing as a consequence.

### Tests on Cement Specimens

The tensile strength of (mini) rebars 10A to 10D was tested. To this end, one end of the rebar 10A to 10D was embedded in a paving block of cement composition. The length set in was 40 mm and the cement composition comprised:
Portland cement CPA52.5: 75 parts by weight,
sand: 25 parts by weight,
water: 32 parts by weight.

The cement block reinforced in this way was then aged according to the following cycle:
1 hour in the open air,
4 days in water at ambient temperature,
24 hours in the open air.

The tensile force necessary to pull out the rebar was measured. The idea for this test was taken from the “SIC” or Strand in Cement” test.

The pull-out resistance was greater than the force necessary to break the rebar. Rather than sudden and brittle fracture, it was observed that for each of the rough rebars 10A to 10D these were progressively laid bare by a succession of “elementary pull-outs”, that is to say successive detachment of the “points” of the rough parts of the rebars. These bars therefore gave the reinforced cement the desired “ductility” in the case of damage by an excess load.

In order to compare the various types of sheaths of mini rebars n° 3a to n° 3f it was chosen to reduce the force of attachment of the cord in the cement matrix by cutting the cement cube to 2 cm in order to reduce the length of attachment of the cord in the cement and in this way to cause the cord to slide in the block of cement.

Table 2 indicates the maximum strength (in N/cm) of mini rebars before breaking, by sliding of the cord (with the cement). It was observed that the rough sheath of the mini rebars n° 3c to 3f made it possible to increase significantly the attachment of the cord in the cement.

TABLE 2

| Reference of | | Maximum holding strength |
|---|---|---|
| mini rebars | Type of break | in cement (in N/cm) |
| N° 3a | slide | 99 |
| comparative | | |
| N° 3b | slide | 70.5 |
| comparative | | |
| N° 3c | slide | 364 |
| N° 3d | slide | 404 |
| N° 3e | slide | 448 |
| N° 3f | slide | 494 |

Cement Beam Tests

Cement beams were prepared 2 cm×2 cm×16 cm in size. The cement matrix used was a conventional matrix composed of 57% cement, 19% LA 32 sand and 24% water.

A beam A was reinforced with the mini rebar reference n° 3a and a beam B was reinforced with the mini rebar n° 3f according to the invention.

After 24 h in water and then 13 days at ambient temperature, the beams A and B were broken in “3-point” bending. The test was carried out with a distance between supports of 10 cm (in an order to obtain a bending stress) and with a rate of displacement of 1 mm/min. The rebars n° 3a and n° 3f were placed at ⅓ of the thickness of the beams A, B during stress. The displacement of the crosspiece was constant and the force (in N) and the displacement (in mm) were noted.

FIG. 9 thus shows two curves 1000A and 1000B giving respectively the changes in force (in N) as a function of the displacement of the crosspiece (in mm) for the beams A and B.

Two different types of behaviour will be noticed between beams A and B. Beam B shows better strength when stressed after break. The sheathing present on the mini rebar 3f used in the beam B acts to hold the beam together after cracking.

Two zones of the curves 1000A, 1000B are noteworthy:
points X, X′ which express breakage of the cement beam
the slopes taken just after the points X, X′, symbolize the force take-up by the rebars after the cement has cracked.

The sheathing is indeed secured to the cord and there is no sliding of the sheath over the cord.

After the cement has broken, it will be seen that the reference beam A permits a very small force take-up, much lower than the force to break the beam. The reinforced beam B also makes possible to take up forces after breakage of the cement beam. This take-up is much greater and even enables the initial breaking force of the beam to be exceeded. The steep slope reveals the phenomena of friction and energy absorption as the rough mini rebars are progressively laid bare in the cement matrix.

The mini rebar with a rough sheath n° 3f has thus indeed an effect in a cement matrix and it makes it possible to preserve the integrity of the structure after this has cracked.

1-17. (canceled)

18. A method for producing a rough elongate composite element, comprising:
introducing simultaneously into a sheathing device an essentially solid cord based on an organic material and reinforcing yarns as well as a mixture including a molten thermoplastic and at least one of the following constituents: a reinforcement and a filler, the cord being pulled by a haul-off mechanism downstream from the sheathing device; and
sheathing the cord by forming a layer of the adherent mixture onto the cord, a roughness of the sheath formed in this way being created by the sheathed cord leaving the sheathing device.

19. A method for producing the rough elongate composite element according to claim 18, wherein, when the mixture is pressed during the forming of the layer, pressure is adjusted according to the constituents and from at least one of the following parameters: feed rate of the mixture, pull speed of the cord, dimensions of a zone forming the layer of the sheathing device, and a size of an outlet opening of the sheathing device.

20. A method for producing the rough elongate composite element according to claim 18, wherein the organic material is thermoplastic.

21. A method for producing the rough elongate composite element according to claim 18, wherein the reinforcement comprises filaments.

22. A method for producing the rough elongate composite element according to claim 21, wherein the filaments comprise alkali-resistant glass filaments.

23. A method for producing the rough elongate composite element according to claim 21, wherein the reinforcing yarns comprise alkali-resistant glass yarns.

24. A method for producing the rough elongate composite element according to claim 18, wherein, before the introducing the mixture, at least part of the mixture is prepared by unreeling wound multifilament yarns, chopping the yarns to form fibers, and dispersing the yarns in an extruder feeding the device for sheathing the fibers in the thermoplastic.

25. A method for producing the rough elongate composite element according to claim 18, wherein, before the introducing of the mixture, at least part of the mixture is prepared by incorporating at least one compound comprising filaments and the thermoplastic in an extruder feeding the sheathing device.

26. A method for producing the rough elongate composite element according to claim 18, further comprising forming the cord including introducing a bundle of the reinforcing yarns associated with an organic material in a forming device, so as to obtain the cord made by bringing the reinforcing yarns together contiguously, forming transverse continuity.

27. A rough elongate composite element comprising:
a core based on an organic material and reinforcing yarns and that is covered with a rough sheath based on a thermoplastic and at least one of the following constituents: a reinforcement comprising filaments or talc, the rough sheath being then provided with beads and then exhibiting a fluffy appearance, the element configured to be obtained by the production method according to claim 18.

28. A rough elongate composite element according to claim 27, wherein the reinforcement comprises glass filaments, or alkali resistant glass filaments, with a distribution of lengths between 0.5 and 5 mm.

29. A rough elongate composite element according to claim 27, wherein the reinforcement comprises glass filaments, or alkali resistant glass filaments, with a mean length of between 0.2 and 0.5 mm.

30. A matrix with a hydraulic binder incorporating the rough elongate composite element according to claim 27.

31. An element based on a hydraulic binder matrix reinforced with the rough elongate composite element according to claim 27.
